(19) United States
(12) Patent Application Publication
(10) Pub. No.: US 2024/0300214 A1
(43) Pub. Date: Sep. 12, 2024

(54) Gods Skin

(71) Applicant: DeMarcus Oshay Carney, Winston Salem, NC (US)

(72) Inventor: DeMarcus Oshay Carney, Winston Salem, NC (US)

(21) Appl. No.: 18/171,610

(22) Filed: Mar. 6, 2023

(51) Int. Cl. B32B 9/04; B32B 9/00

(52) U.S. Cl. CPC B32B 9/041; B32B 9/007; B32B 2250/40; B32B 2307/746

(57) ABSTRACT

My invention is comprised of only three components: superfluid helium-4, graphene, and mercury telluride. When these three pieces are arranged in a tri-layer so that the mercury telluride encases the graphene, and superfluid helium-4, a frictionless environment is created within this structure. My invention could potentially replace the gold wrapped silicon ion traps in some of todays quantum computers, through an embodiment of my invention, or by simply wrapping my invention in gold. Electrical signals in my innovative tri-layer will be enabled in such a way that they can travel through this tri-layer instantly.

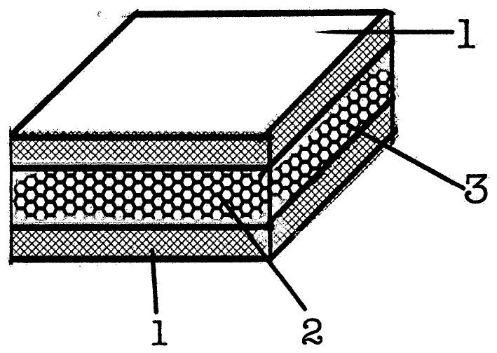

My invention will be referred to as my frictionless tri-layer and it is composed a layer of graphene 2 that has been infused with superfluid helium-4 3, and all of this is trapped in between two separate layers of mercury telluride 1. My frictionless tri-layer could be tested and used with the processors that are inside of quantum computers.

### FIELD OF INVENTION

The current field of my frictionless tri-layer is theoretical physics, until experimental testing is completed. My frictionless tri-layer would be best fit in the realm of quantum computing.

### BACKGROUND ART

In the field of quantum computing there are some present hurdles that researchers must currently overcome. The biggest challenge in quantum computing lies within the physical processors of the said computers. One word sums up the major problem and that word is decoherence. Decoherence is basically the loss of information to a system or in laments terms, an error in quantum computing. Decoherence is caused by changes in the magnetic and or electrical fields, radiation from nearby warm objects, and the unwanted interactions in between qubits.

### SUMMARY OF INVENTION

I've coined the term “Frictionless Tri-layer” due to the fact that scientifically, in theory, a true frictionless habitat exists within this tri-layer system. Within this mercury telluride 1 bi-layer, the combination of superfluid helium-4 3 infused graphene 2 creates an environment in which electrical currents can travel through the graphene 2 with little to no resistance. My frictionless tri-layer has the potential to upgrade a component in a certain type of quantum computer. The current “ion traps” in ion trap quantum processors are composed of just two elements: Silicon wrapped in Gold. An embodiment of my frictionless tri-layer could be simply wrapping it in Gold in lieu of using a Gold wrapped Silicon ion trap. Using my tri-layer invention as an ion trap has the potential to fix decoherence in this certain type of quantum processing system by providing qubits with an area of almost no resistance for the electrical signals to travel.

### DESCRIPTION OF THE DRAWING(S)

The mercury telluride 1 bilayer is represented as the top and the bottom layers of my frictionless tri-layer invention. The inverted tile like squares show exactly where the mercury telluride 1 is to be placed during the formation of this structure. The graphene 2 is illustrated by the hexagonal formations within this image. Graphene 2 is a single layer of carbon atoms that are arranged into a hexagonal lattice on the nanoscopic scale, this is why a repeating pattern of hexagons was used to illustrate the graphene 2 within my frictionless tri-layer invention. Graphene 2 is porous and in the complete embodiment of my invention, the graphene 2 within will be totally saturated with superfluid helium4 3. The black lines of the hexagons represent carbon atoms, or graphene 2, and the white filling of these hexagons is imposed as the superfluid helium4 3. There is no empty space left anywhere within this tri-layer. The graphene 2 is being touched by the mercury telluride 1 on both sides and the superfluid helium4 3 is completely saturating all of the interior of my frictionless tri-layer invention.

### DESCRIPTION OF THE INVENTION

The properties of the three components that are in my frictionless tri-layer would lead one to believe that an electrical signal can be passed through the interior of this tri-layer with little to no resistance. The first component would be the mercury telluride 1, which normally comes in powder form or in pellets. Mercury telluride 1 is a semiconductor with an insulating bulk, meaning it's electrons specifically collect on its exterior. This is the basis of my tri-layer because of the insulating bulk. It's almost as if electrons skip traveling through mercury telluride's 1 bulk and just appear on its surface. Since I am proposing that my invention will replace the current gold wrapped silicon quantum processor computer chips, it may be worth considering that mercury telluride 1 naturally occurs in gold deposits in nature. This fact possibly means that the mercury telluride 1 of my invention would positively interact with gold, if it were to be wrapped in gold and to be used as an ion trap in a quantum processor.

The next solid component of my tri-layer is graphene 2, which is a single layer of carbon atoms arranged in a hexagonal lattice structure. Graphene 2 is semiconductor and so is mercury telluride 1 so I believe that these two compounds will interact productively. Graphene 2 also has properties that allow for its electrons to move freely across the graphene 2 layer. It's common knowledge that graphene 2 is in a vast majority of today's touchscreen devices, which proves its potential to carry electrical signals extremely well.

The last component of my frictionless tri-layer is simply the addition of superfluid helium-4 3 to the interior of the my frictionless tri-layer. Superfluid helium-4 3 flows with zero resistance and no friction. This fact makes superfluid helium-4 3 the perfect candidate to improve the efficiency of graphene's 2 already great ability to transfer electrical signals. When this whole system is assembled, a frictionless environment is created within the tri-layer, for electrical signals to be carried through. The insulating bulk of mercury telluride 1 already allows for effortless electron flow and the addition of superfluid helium-4 3 will only amplify this. The graphene 2 would carry the electoral signals in this environment, that could theoretically lack electrical resistance.

The solid components of my tri-layer invention are very easy to manufacture. Graphene 2 is a thin layer of carbon that must be pressed, with extreme delicacy, in between two separate mercury telluride 1 sheets. Adding superfluid helium-4 3, which has a temperature requirement of almost 2 Kelvin, could potentially be an obstacle for ordinary physicists when trying to replicate this experiment. When wrapped in gold, my frictionless tri-layer, could serve as more of a superior alternative to the simple, silicon wrapped in gold, chips that are currently used today in the ion traps of some quantum computers.

1. (canceled)

2. My frictionless tri-layer includes a layer of graphene, that has been infused with superfluid helium-4, and these two components are encased in between a mercury telluride bilayer.

3. A tri-layer comprising: a layer of graphene infused with superfluid helium-4; and said layer of graphene and superfluid helium-4 encased between a mercury telluride bilayer.

4. The tri-layer of claim 3, further comprising a layer of gold surrounding the mercury telluride bilayer.

5. (canceled)

6. A tri-layer comprising: a layer of graphene infused with superfluid helium-4; and said layer of graphene and superfluid helium-4 encased between a mercury telluride bilayer.

7. The tri-layer of claim 6, further comprising a layer of gold surrounding the mercury telluride bilayer.
